(19) United States
(12) Patent Application Publication
(10) Pub. No.: US 2008/0031255 A1
(43) Pub. Date: Feb. 7, 2008

(54) Module for Network Interface Card

(76) Inventors: Andrew James Barker, Nottinghamshire (GB); Alnashir Lalani, Derbyshire (GB); Brendan Devaney, Nottingham (GB)

Correspondence Address: COATS & BENNETT, PLLC, 1400 Crescent Green, Suite 300, Cary, NC, 27518, US

(21) Appl. No.: 10/596,881

(22) PCT Filed: Dec. 15, 2004
(86) PCT No.: PCT/EP04/53482

§ 371 Date: Oct. 9, 2006

(30) Foreign Application Priority Data
Jan. 7, 2004 (GB) 0400182.2

(51) Int. Cl. H04L 12/28

(52) U.S. Cl. 370/395.1

(57) ABSTRACT

A telecommunications interface network card, such as the type which is inserted into a suitable slot in a rack forming a network node, to provide an interface to the node for telecommunications traffic entering and leaving the node, typically carries a receptacle to receive a plugable module which contains a laser and receiver as optical interface, allowing one card to be used with a number of optical interfaces, to avoid the need for a range of cards to be produced, each dedicated to one particular type of traffic, for example, a particular distance and data rate. The invention provides a module which is compatible with existing optical modules, but which carries an electrical interface.

This invention relates to plugable modules for telecommunications network interface cards. Such cards are inserted into suitable slots in racks forming network nodes such as access hubs. The cards provide an interface to the hub for telecommunications traffic entering and leaving the card, and the hub provides, among other things, communication between the cards via a backplane. The access hub communicates with other nodes of the network.

The telecommunications traffic entering the card may be optical and of various bit rates (e.g. 155 Mbit/s, 622 Mbit/s etc) and types (e.g. short haul, long haul), or may be electrical for short distance interconnection which has a cost advantage (e.g. if the access hub is to be connected to another piece of equipment in the same building). Traditionally, transmission interfaces have been designed on a custom basis, with the circuitry designed into the main card on which they reside. Thus, a particular card may have a photosensitive receiver and a laser of chosen wavelength and adapted for reception and transmission over a chosen distance.

A problem caused by the range of interface types is that many separate card designs are required to support each interface type. These require extra design resource, and result in the need to support multiple card designs in production. To overcome this, various universal (core) card designs have been produced, which do not carry the laser and receiver on the card, but simply a receptacle to receive a plugable module (carrier) which contains the laser and receiver. One universal card can then be manufactured instead of one for each laser type as hitherto, and the appropriate one of a range of plug-in modules each with a receiver and laser of different type, can be fitted to the universal card. (Typically, the module has sleeves to receive optical fibres optically to connect to the receiver and laser). This allows a small number of universal cards to be designed, with interface variation being achieved by fitting the appropriate plug-in module. The card bears contacts for mating with co-operating contacts on the plug-in module when it is fitted. The plugable optical modules, which provide the actual optical interface, are called Small Form Plugables (SFPs). They integrate the optical interface and main card interface circuitry into a single plug-in module. To ensure compatibility, a Multi Source Agreement (MSA) is in place covering the card facing interface and physical parameters of the modules.

According to a first aspect of the invention there is provided a plugable module for a telecommunications network interface card, the telecommunications network interface card including a Small Form Plugable receptacle interface, wherein the plugable module is arranged to be received by the Small Form Plugable receptacle interface on one side and to provide an electrical connection to a further telecommunications network unit on the other side, the electrical connection being compatible with a predefined electrical interface rate.

According to a second aspect of the invention, there is provided a plugable module for a telecommunications network interface card which has a receptacle to receive an optical interface module, wherein the module has an electrical interface.

Hitherto, it was necessary to provide a dedicated telecommunications network interface card in order to provide an electrical interface. The module is compatible with existing telecommunications network interface cards, that is, has appropriate physical dimensions and electrical characteristics.

Advantageously, the plugable module could be adapted to interface with ITU SONET, SDH or PDH interface rates.

A plugable module for a telecommunications network interface card will now be described in detail, by way of example only, with reference to the accompanying drawings, in which:

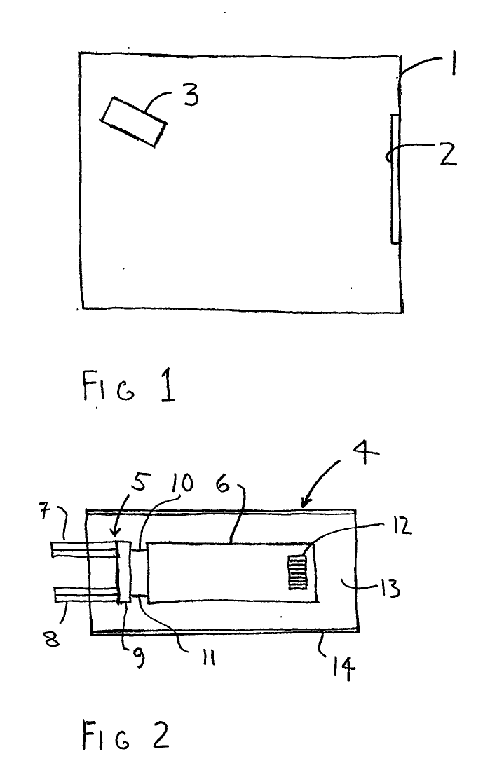

FIG. 1 is a plan view of a telecommunications network interface card;

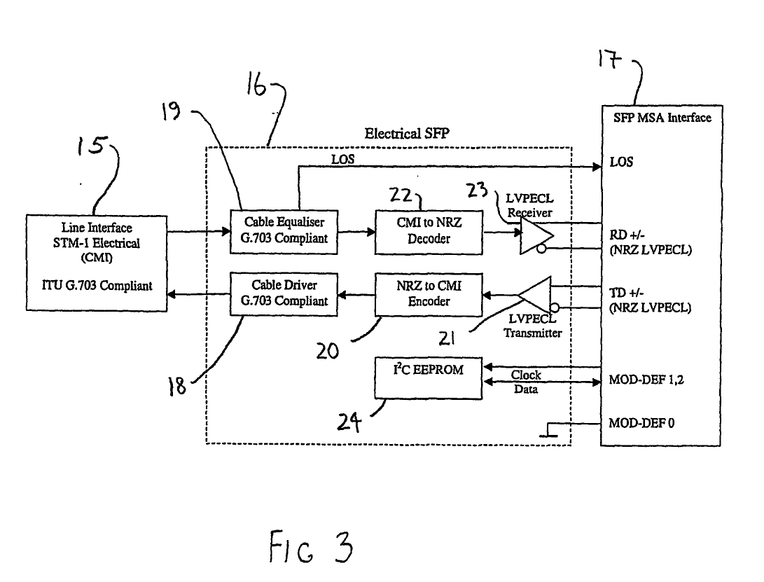

FIG. 2 is a plan view of the plugable module; and

FIG. 3 is a block circuit diagram of the plugable module.

Referring to FIG. 1 and FIG. 2 of the drawings, a telecommunications network interface card 1 has a bank of contacts 2 to co-operate with contacts in a node such as an access hub. The card bears circuit components (not shown) such as integrated circuits. The card also bears a carrier 3 for a plugable module such as an SFP. Such an SFP typically forms the optical interface for the card. The carrier 3 is a sleeve of rectangular form, with the long side of the rectangle lying on the face of the card. The sleeve is open to receive the SFP at its end nearer to the edge of the card. Normally, the card would be mounted with its plane vertical in the node, with the contacts engaged with those in the node. The SFP would be received into the left-hand end, and would engage contacts towards the right-hand end.

In accordance with the invention, a plugable module 4 is designed so as to be able to plug into the known carrier, but the module has an electrical interface in place of an optical one. Hitherto, it has been necessary to provide a separate electrical card for the card to interface to an electrical network. Referring to FIG. 2, the module consists of a terminal block 5 and a printed circuit board 6. The terminal block 5 has two coaxial plugs 7,8 mounted on a support block 9. Leads 10, 11 connect the terminal block 5 to the printed circuit board 6, which bears components (not shown), and contacts 12 for connecting with co-operating contacts on the card 1. The terminal block and printed circuit board are encapsulated in a one-piece body of plastics material, which has an opening to allow access to the contacts 12. The body is surrounded by a thin sleeve of metal 14 to suppress electromagnetic radiation.

Since the same physical design parameters and card facing interface are used as for the known optical SPFs, the device designed will fit into existing designs of optical interface cards implemented with SFPs, while providing the required electrical interface, such as STM-1 or other SDH rate as defined by ITU. By adhering to the Multi Source Agreement (MSA) for the physical parameters and card facing interfaces, direct plug-in compatibility is achieved.

The invention provides flexible electrical interfaces with existing designs of SFP based optical interface cards.

The module may provide an interface for SDH (synchronous digital hierarchy) transmission, such as an STM-1 (155.52 Mbit/s) electrical interface. Equally, the module could provide an interface for other SDH electrical interfaces rates, as designated by ITU (e.g. 622 Mbit/s, 2.5 Gbit/s etc). Alternatively, other modules may be adapted to provide PDH interfaces and, particularly where they are close in bit rate, the bit rates can effectively be paired, for example, 1.5 & 2 Mbit/s, 34 & 45 Mbit/s etc. The module provides a flexible design, providing easy plug-in adaptation of the interface rate.

Referring to FIG. 3, a block diagram of an implementation for a SDH STM-1 electrical interface is shown. The electrical input to the module is shown as box 15. The circuit on the printed circuit board 6 is shown in box 16, and the interface on the telecommunications network interface card is shown in box 17. The cable driver 18 is for the STM-1 output, and the cable equaliser 19 is for the STM-1 input. Loss of signal at the input is signaled directly to the interface card. Amplification and coding are provided in boxes 20, 21, respectively, for transmission, and decoding and amplification are provided in boxes 22,23, for reception. Box 24, an EEPROM, is a non volatile storage device. It is used to hold information about the module such as: module type; interface type; date of manufacture; place of manufacture; and serial number.

1 -10. (canceled)

11. A pluggable module for a telecommunications network interface card, the module comprising:
a first side configured to be received by a Small Form Pluggable (SFP) optical receptacle disposed on the telecommunications network interface card; and
an electrical connector configured to electrically connect the pluggable module to a telecommunications network unit at a predefined electrical interface rate.

12. The pluggable module of claim 11 wherein the predefined electrical interface rate comprises at least one of a SONET interface rate, a PDH interface rate, and an SDH interface rate.

13. The pluggable module of claim 12 wherein the predefined electrical interface rate comprises an SDH STM-n electrical rate.

14. A pluggable module for a telecommunications network interface card, the module comprising:
an interface compatible with a Small Form Pluggable (SFP) optical receptacle; and
an electrical interface configured to electrically connect the pluggable module to a telecommunications network unit at a predefined electrical interface rate.

15. The pluggable module of claim 14 wherein the interface comprises a first amplifier configured to amplify electrical signals transmitted to the SFP receptacle and a second amplifier configured to amplify electrical signals received from the SFP receptacle.

16. The pluggable module of claim 15 wherein the electrical interface comprises a driver configured to transmit electrical signals to the telecommunications network unit, and an equalizer configured to receive electrical signals from the telecommunications network unit.

17. The pluggable module of claim 16 further comprising an encoder to encode the electrical signals being received by the second amplifier into the electrical signals being transmitted by the driver, and a decoder to decode the electrical signals received by the equalizer into the electrical signals being transmitted by the first amplifier.

18. The pluggable module of claim 16 wherein the equalizer is further configured to interface with the SFP receptacle.

19. The pluggable module of claim 16 further comprising memory configured to interface with the SFP receptacle.

20. The pluggable module of claim 14 further comprising one or more connectors molded into a block of plastic.

21. The pluggable module of claim 20 further comprising a printed circuit board including one or more contacts molded in the block of plastic, the one or more contacts being configured to interface the pluggable module with the telecommunications network interface card.

22. The pluggable module of claim 14 wherein the module is configured to interface with the telecommunications network interface card at least one of a SONET rate, an SDH rate, and a PDH rate.

23. The pluggable module of claim 22 wherein the module is configured to interface with the telecommunications network interface card at an SDH STM-n rate.
